(19) United States
(12) Patent Application Publication
(10) Pub. No.: US 2014/0024461 A1
(43) Pub. Date: Jan. 23, 2014

(54) Replacing Players on a Collaborative Game Task in an Online Game

(71) Applicant: Zynga Inc., San Francisco, CA (US)

(72) Inventors: Jeff Rodkey, San Francisco, CA (US); Tatung Mei, San Francisco, CA (US); Kyle Sampson, San Francisco, CA (US); Cesario Julation, San Francisco, CA (US); Yi Qiang, San Francisco, CA (US)

(73) Assignee: Zynga Inc., San Francisco, CA (US)

(21) Appl. No.: 13/948,102

(22) Filed: Jul. 22, 2013

Related U.S. Application Data
(60) Provisional application No. 61/674,808, filed on Jul. 23, 2012.
(60) Provisional application No. 61/674,756, filed on Jul. 23, 2012.

(51) Int. Cl. A63F 13/12

(52) U.S. Cl. CPC A63F 13/12
USPC 463/42

(57) ABSTRACT

Software at an MMO game website creates a team to perform a collaborative game task in an MMO game. The collaborative game task is composed of a plurality of individual game tasks. Each player on the team is assigned an individual game task by the software. The software removes an existing player from the team, if the existing player is not participating, and the software assigns a new player to a team. The software determines that the team has satisfactorily completed the collaborative game task associated with the team, according to game mechanics associated with the collaborative game task. Then the software terminates provides a game reward to each player on the team.

### RELATED APPLICATIONS

This application claims priority to Provisional Application Ser. No. 61/674,808, entitled “Replacing Players in a Collaborative Game Task in an Online Game”, filed on Jul. 23, 2012, and Provisional Application Ser. No. 61/674,756, entitled “Rewarding Participating Players on a Collaborative Game Task in an Online Game”, also filed on Jul. 23, 2012. This application is related to application Ser. No. ______, Attorney Docket No. ZYNP025, entitled “Rewarding Participating Players on a Collaborative Game Task in an Online Game”, which was contemporaneously filed. The disclosures of all of the above applications are incorporated herein by reference.

### BACKGROUND

Collaborative game tasks are sometimes used in board games to increase player engagement, as such tasks are inherently social. Of course, such tasks bear more than some resemblance to real-world collaborative tasks, which tend to be managed through project-management processes including monitoring and controlling task activities.

Online games, including massively multiplayer online (MMO) games, tend to have a large number of players who can be described as “casual” (as opposed to “hardcore”). Such players are willing to devote only a small amount of their time and resources to game play and would be put off by any collaborative game task that resembled a real-world project.

Consequently, creating collaborative game tasks for casual online gamers continues to be an ongoing area of research and experimentation for the designers of online games.

### SUMMARY

In an example embodiment, a processor-executed method is described for engaging players in a massively multiplayer online (MMO) game. According to the method, software at a website hosting an MMO game creates a team (or group) to perform a collaborative game task in the MMO game. The collaborative game task is composed of a plurality of individual game tasks. Each player on the team is assigned an individual game task by the software. The software removes an existing player from the team, if the existing player is not participating, and assigns a new player to the team. The software determines that the team has satisfactorily completed the collaborative game task, according to the game mechanics associated with the collaborative game task. Then the software provides a game reward to each player on the team.

In another example embodiment, an apparatus is described, namely, a computer-readable storage media that persistently store a program for engaging players in an MMO game. The program might be part of the software at a website hosting the MMO game. The program creates a (or group) to perform a collaborative game task in the MMO game. The collaborative game task is composed of a plurality of individual game tasks. Each player on the team is assigned an individual game task by the program. The program removes an existing player from the team, if the existing player is not participating, and the program assigns a new player to the team. The program determines that the team has satisfactorily completed the collaborative game task, according to the game mechanics associated with the collaborative game task. Then the program provides a game reward to each player on the team.

Another example embodiment also involves an apparatus for engaging players in an MMO game, e.g., a server at a website hosting an MMO game. The apparatus includes one or more processors and memory storing processor-executable instructions. The instructions create a team (or group) to perform a collaborative game task in the MMO game. The collaborative game task is composed of a plurality of individual game tasks. Each player on the team is assigned an individual game task by the program. The instructions remove an existing player from the team, if the existing player is not participating, and the program assigns a new player to the team. The instructions determine that the team has satisfactorily completed the collaborative game task, according to the game mechanics associated with the collaborative game task. Then the instructions provide a game reward to each player on the team.

Other aspects and advantages of the inventions will become apparent from the following detailed description, taken in conjunction with the accompanying drawings, which illustrate by way of example the principles of the inventions.

### BRIEF DESCRIPTION OF THE DRAWINGS

FIG. 1 is a simplified diagram that illustrates a network for an MMO game, in accordance with an example embodiment.

FIG. 2A is a functional software modularization, in accordance with an example embodiment.

FIG. 2B is an alternative functional software modularization, in accordance with an example embodiment.

FIG. 3 is a flowchart diagram that illustrates a process for replacing a player on team performing a collaborative game task in an MMO game, in accordance with an example embodiment.

FIG. 4 is a flowchart diagram that illustrates a process for obtaining a new player on a team performing a collaborative game task in an MMO game, in accordance with an example embodiment.

FIG. 5 is a flowchart diagram that illustrates a process for providing game rewards to encourage participation on a team performing a collaborative game task in an MMO game, in accordance with an example embodiment.

FIG. 6 is a dialog view in a graphical user interface (GUI) that allows a player to join a team performing a collaborative game task in an MMO game, in accordance with an example embodiment.

FIGS. 7 and 8 are dialog views in a GUI that notify a player about the status of the formation of the player's team in an MMO game, in accordance with an example embodiment.

FIGS. 9-11 are dashboard views in a GUI for a team performing a collaborative game task in an MMO game, in accordance with an example embodiment.

FIG. 12 is a dialog view in a GUI that allows a player to quit a team performing a collaborative game task in an MMO game, in accordance with an example embodiment.

FIG. 13A is a simplified diagram that illustrates a sequence of transmissions associated with an individual game task (e.g., preparing a virtual dish in a virtual meal) in an MMO game accessed from a social networking website, in accordance with an example embodiment.

FIG. 13B is a simplified diagram that illustrates a sequence of transmissions associated with an individual game task (e.g., preparing a virtual dish in a virtual meal) in an MMO game accessed from an MMO game website, in accordance with an example embodiment.

### DETAILED DESCRIPTION

In the following description, numerous specific details are set forth in order to provide a thorough understanding of the exemplary embodiments. However, it will be apparent to one skilled in the art that the example embodiments may be practiced without some of these specific details. In other instances, process operations and implementation details have not been described in detail, if already well known.

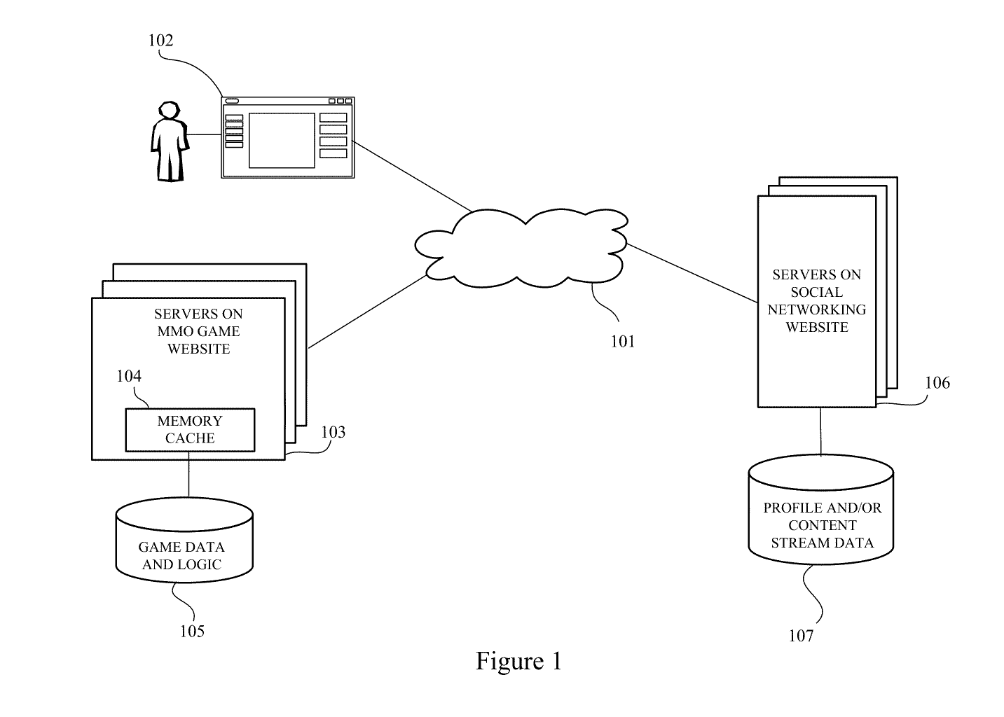

FIG. 1 is a simplified diagram that illustrates a network for an MMO game, in accordance with an example embodiment. As depicted in this figure, a personal computing device 102 is connected by a network 101 (e.g., a wide area network (WAN) including the Internet, which might be wireless in part or in whole) with a website 103 hosting a massively multiplayer online (MMO) game (e.g., a website such as Zynga hosting FarmVille or Blizzard Entertainment hosting World of Warcraft) and a website 106 hosting a social network (e.g., a social networking website such as Facebook). As used here and elsewhere in this disclosure, the term “social networking website” is to be broadly interpreted to include, for example, any website that allows its users to selectively access (e.g., according to a contact list, buddy list, social graph, or other access control list (ACL)) content in each other's profiles and/or streams or selectively communicate (e.g., according to a contact list, buddy list, social graph, or other ACL) with each other (e.g., using a messaging protocol such as email, instant messaging, short message service (SMS), etc.).

The personal computing device 102 might be (a) a laptop or other personal computer or (b) a mobile device such as a smartphone, (e.g., an iPhone, Blackberry, Android, etc.), a tablet computer (e.g., an iPad), etc. In an example embodiment, each of the websites 103 and 106 might be composed of a number of servers connected by a network (e.g., a local area network (LAN) or a WAN) to each other in a cluster or other distributed system which might execute cloud platform software. The servers in website 103 and 106 might also be connected (e.g., by a storage area network (SAN)) to persistent storages 105 and 107, respectively. In an example embodiment, persistent storages 105 and 107 might include a redundant array of independent disks (RAID).

Persistent storage 105 might be used to store algorithms and data related to an MMO game and its players, including data about the players received by website 103 from website 106 (e.g., through an application programming interface (API) exposed by website 106). In an example embodiment, some of the data from persistent storage 105 might be cached in memory cache 104 in volatile memory on servers on website 103 (e.g., using (a) an in-memory database or main memory database system (MMDB) or (b) a hybrid in-memory database that also uses persistent storage) in order to improve performance. Persistent storage 107 might be used to store data (including content) associated with a profile and/or stream for members of a social network (or social graph), e.g., users who are associated with each other through access-control lists (ACLs).

As indicated above, personal computing device 102 might be a laptop or other personal computer. In that event, personal computing device 102 and the servers in website 103 and 106 might include (1) hardware consisting of one or more microprocessors (e.g., from the x86 family or the PowerPC family), volatile storage (e.g., RAM), and persistent storage (e.g., a hard disk or solid-state drive), and (2) an operating system (e.g., Windows, Mac OS, Linux, Windows Server, Mac OS Server, etc.) that runs directly or indirectly (e.g., through virtualization software) on the hardware. Or the operating system for the servers might be replaced by a hypervisor or other virtualization software. Alternatively, personal computing device 102 might be a smartphone, tablet computer, or other mobile device that includes (1) hardware consisting of one or more low-power microprocessors (e.g., from the ARM family), volatile storage (e.g., RAM), and persistent storage (e.g., flash memory such as microSD) and (2) an operating system (e.g., Symbian OS, RIM BlackBerry OS, iPhone OS, Palm webOS, Windows Mobile, Android, Linux, etc.) that runs on the hardware.

Also in an example embodiment, personal computing device 102 might include a web browser as an application program or part of an operating system. Examples of web browsers that might execute on personal computing device 102 if it is a laptop or other personal computer include Internet Explorer, Mozilla Firefox, Safari, and Google Chrome. Examples of browsers that might execute on personal computing device 102 if it is a smartphone, tablet computer, or other mobile device include Safari, Mozilla Firefox, Android Browser, and Palm webOS Browser. It will be appreciated that users of personal computing device 102 might use browsers to communicate with software running on the servers at website 103 and at website 106. Alternatively, users of personal computing device 102 might use other application programs to communicate with software running on the servers at website 103 and at website 106. For example, if the personal computing device 102 is a smartphone, tablet computer, or other mobile device, users might use an app or a hybrid app (e.g., an app written in Objective C or Java that includes embedded HTML5) to communicate with software running on the servers at website 103 and at website 106. It will be appreciated that an application program for a mobile device is often referred to as an “app”.

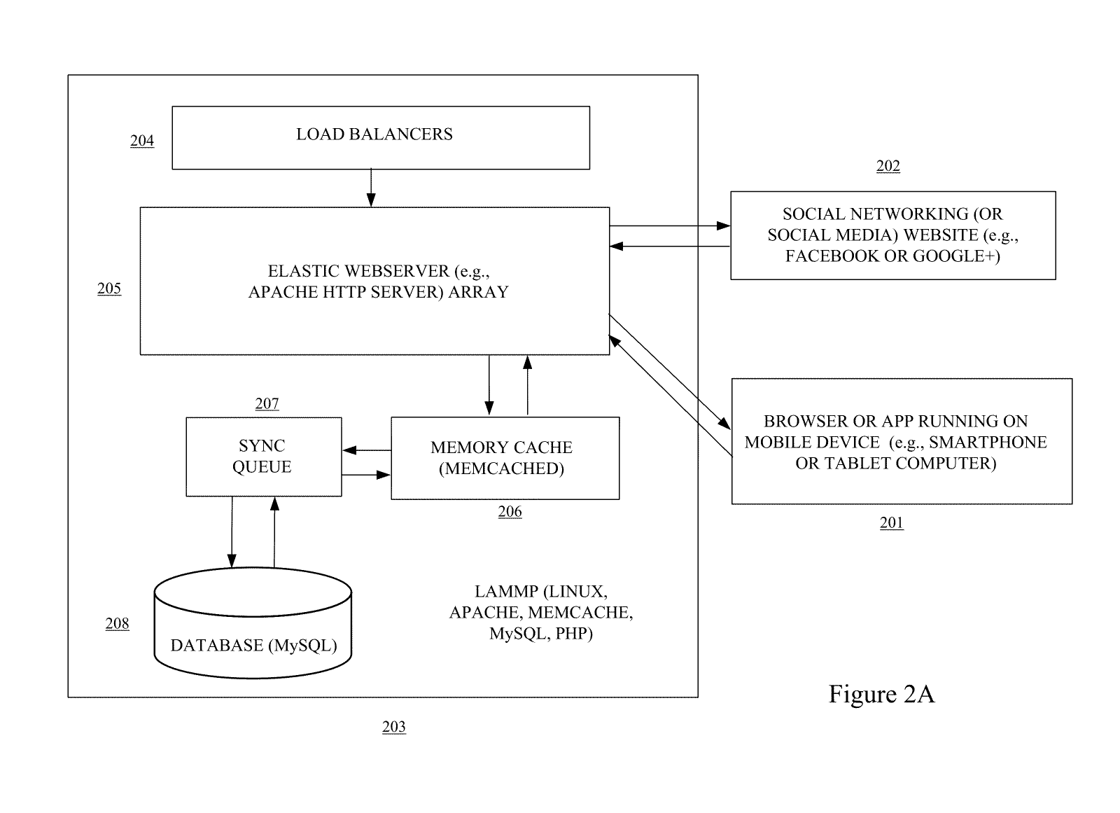

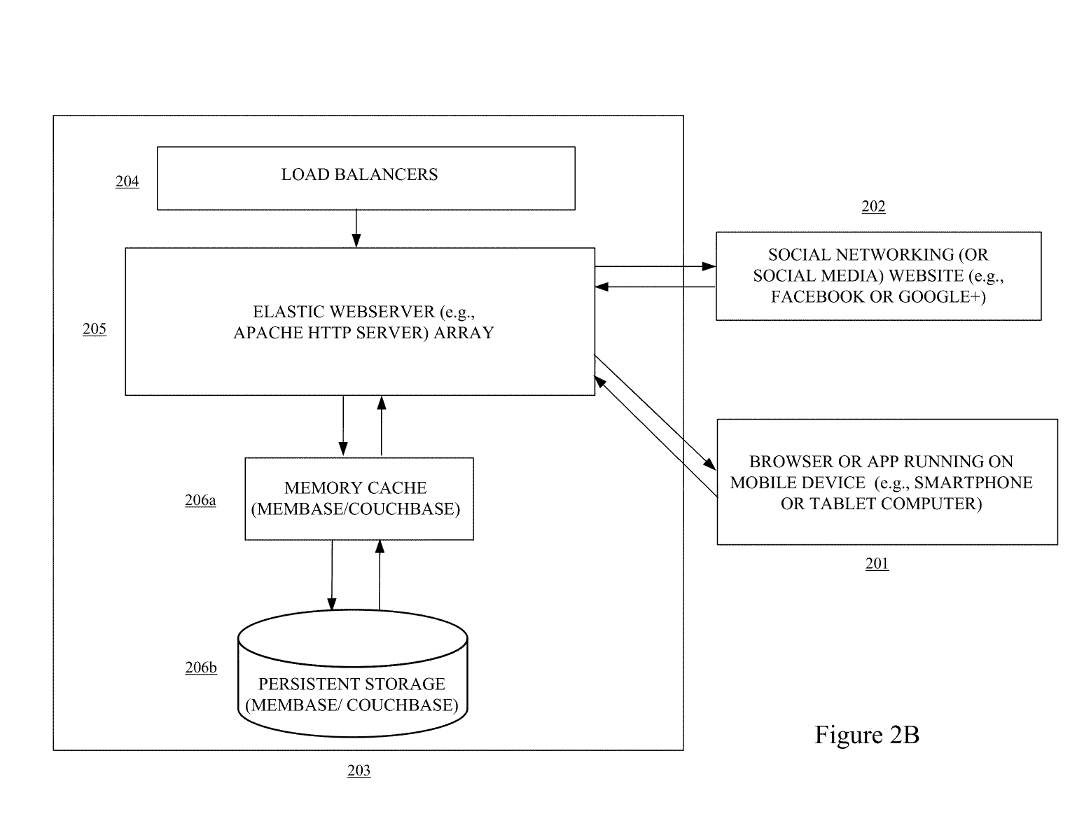

FIG. 2A is a functional software modularization, in accordance with an example embodiment. As depicted in this figure, a player is using a web browser or app 201 on a mobile device (e.g., a smartphone or a tablet computer) to interact with server software 203 (e.g., transmit or receive game data) running on a website hosting an MMO game (e.g., running on the servers at website 103 in FIG. 1). In an example embodiment, server software 203 might be implemented using a public, private, or hybrid cloud platform, e.g., a hybrid cloud platform whose public cloud is Amazon Electric Compute Cloud (EC2) and whose private cloud is built using Cloud.com's CloudStack software. In an alternative example embodiment, server software 203 might be implemented using other public clouds and/or other private clouds that provide similar functionality. Or, server software 203 might be implemented without resort to third-party cloud platforms, e.g., using load balancing and virtualization software (e.g., Citrix XenServer, VMware, Microsoft, or Xen), distributed computing software (such as Hadoop, which implements Map-Reduce and/or the Google Filesystem), distributed memory-caching software (such as memcached), distributed key-value database software (such as Couchbase Server nee Membase Server), NoSQL database-management software, structured database-management software (such as MySQL), etc. Parenthetically, it will be appreciated that SQL is an acronym which stands for Structured Query Language.

Returning to FIG. 2A, server software 203 includes load balancers 204 (e.g., the load balancing and virtualization software provided by Citrix, VMware, Microsoft, or Xen) that balance the load between the servers (e.g., Apache HTTP servers) in an elastic (or dynamic) array 205. It will be appreciated that the array is elastic because its size can be increased to accommodate additional servers and decreased to accommodate fewer servers. As further depicted in FIG. 2A, the servers in the elastic array 205 transmit (e.g., using HTTP) data to and receive data from (a) the web browser or app 201 and (b) the servers on a social networking website 202 such as Facebook. In an example embodiment, the servers might read data from and write data to memory cache 206 (e.g., a memory cache created with memcached and managed with Couchbase Server), which, in turn, is backed by database 208, which might be MySQL. In an alternative example embodiment, the database 208 might be NoSQL. It will be appreciated that performance latencies can be significantly reduced by such a caching arrangement, which exploits locality of reference. It will also be appreciated that memory cache 104 in FIG. 1 corresponds to the memory cache 206 in FIG. 2 and the persistent storage 105 in FIG. 1 corresponds to the database 208 in FIG. 2A. In an example embodiment, synch queue 207 might receive the data from memory cache 206 to be written asynchronously to the database 208. As indicated on FIG. 2A, the functional software modularization depicted in the figure might be implemented as a LAMMP (Linux, Apache, Memcache, MySQL, PHP) architecture, in an example embodiment.

FIG. 2B is an alternative functional software modularization, in accordance with an example embodiment. As depicted in this figure, a player is using a web browser or app 201 on a mobile device (e.g., a smartphone or a tablet computer) to interact with server software 203 running on a website hosting an MMO game. In an example embodiment, server software 203 might be implemented using a public, private, or hybrid cloud platform. In an alternative example embodiment, server software 203 might be implemented using other public clouds and/or other private clouds that provide similar functionality. Or, server software 203 might be implemented without resort to third-party cloud platforms, e.g., using load balancing and virtualization software, distributed computing software, distributed memory-caching software, distributed key-value database software, NoSQL database-management software, structured database-management (e.g., SQL) software, etc.

In FIG. 2B, server software 203 includes load balancers 204 that balance the load between the servers in an elastic array 205. As further depicted in this figure, the servers in the elastic array 205 transmit data to and receive data from (a) the web browser or app 201 and (b) the servers on a social networking website 202 such as Facebook. In an example embodiment, the servers might read data from and write data to a hybrid in-memory database 206a and 206b which persists data (e.g., a hybrid in-memory database such as Membase/Couchbase Server).

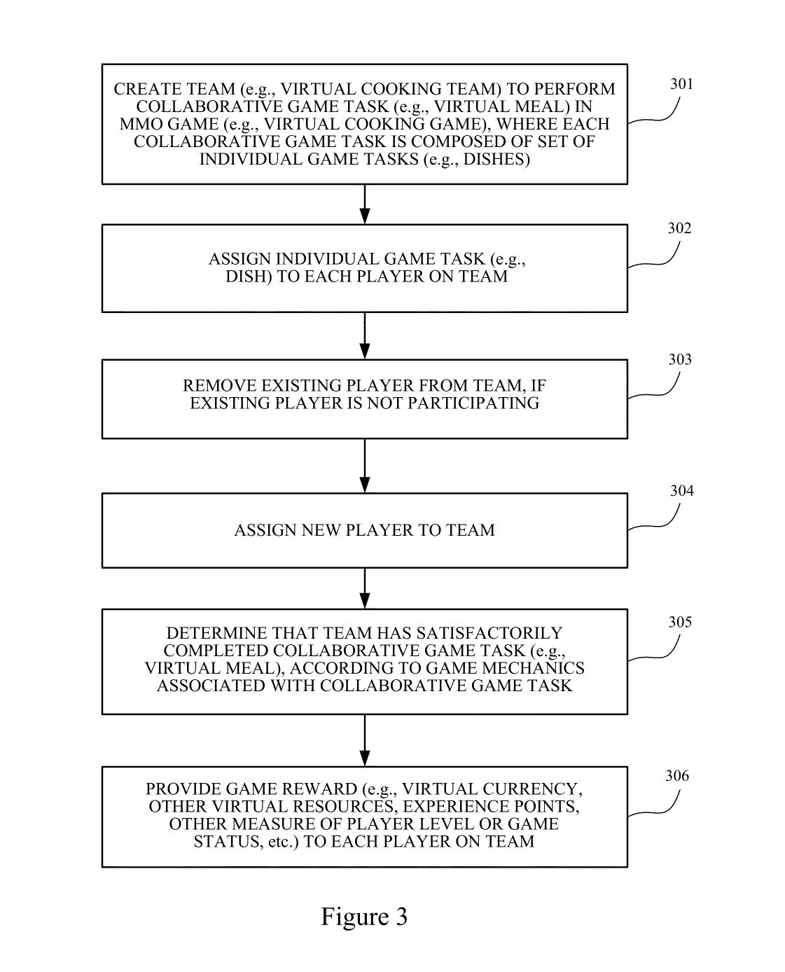

FIG. 3 is a flowchart diagram that illustrates a process for replacing a player on team performing a collaborative game task in an MMO game, in accordance with an example embodiment. In an example embodiment, one or more of the operations in this process might be performed by software (including software 203) running on servers at a website 103, e.g., a website such as Zynga hosting an MMO game. In an alternative example embodiment, one or more of the operations in these processes might be performed by software running on personal computing device 102, e.g., instructions in a webpage read by a browser supporting HTML5, CSS3, and JavaScript or instructions in a hybrid app with embedded HTML5 executing on a smartphone. In another alternative example embodiment, one or more of the operations in these processes might be performed by an Adobe Flash application (e.g., a Small Web Format or SWF file) running on personal computing device 102.

As depicted in FIG. 3, software running on one or more servers at website 103 (e.g., Zynga) creates a team or group (e.g., virtual cooking team) to perform a collaborative game task (e.g., virtual meal) in an MMO game (e.g., virtual cooking game), in operation 301. In an example embodiment, the collaborative game task is composed of set of individual game tasks (e.g., dishes). In operation 302, the software assigns an individual game task (e.g., dish) to each player on the team. It will be appreciated that operations 301 and 302 might be performed at the same time, in an example embodiment. If an existing player on a team is not participating, the software removes the player from the team, in operation 303. In operation 304, the software assigns a new player to the team. Then in operation 305, the software determines that the team has satisfactorily completed the collaborative game task (e.g., virtual meal), according to the game mechanics associated with the collaborative game task. And in operation 306, the software provides a game reward (e.g., virtual currency, other virtual game resource, experience points, other measure of player level or game status, etc.) to each player on the team. As described below, the experience points awarded to a player might be used to determine player level, in an example embodiment. It will be appreciated that the process described in FIG. 3 replaces a non-participating player without resort to any communications that might be considered unpleasant by either the non-participating player or by the other members of that player's team.

In operation 301, the software creates a team. In an example embodiment, teams of a specified size might be created from queues of players (1) who have opted to play the MMO game (e.g., by clicking on a control in a game graphical user interface (GUI)), and (2) who share similar attributes, such as age, gender, language, geo-location (e.g., as determined by IP address, device GPS coordinates, etc.), player level (e.g., greater than 72, as measured in terms of experience points or in terms of points in a reputation system based on both experience and social activity with other players), and gaming activity (e.g., recently inactive, recently casual, recently active, recently hardcore, etc.). In an example embodiment, the queues might be load balanced, e.g., by the addition of a new queue with attributes similar to an existing queue that has grown too long. Also, when assigning players to queues, the software might make a determination as to whether players share similar attributes using clustering analysis, e.g., clustering analysis that depends on a distance between objects (where the objects are players), such as connectivity-based clustering or hierarchy clustering. Some or all of the data as to the player attributes might have been received from a website hosting a social network, e.g., through an application programming interface (API) exposed by that website, in an example embodiment. Or some or all of the data as to player attributes might have come from player profiles maintained by the software at the website hosting the MMO game, including data received from a website hosting a social network. In an alternative example embodiment, teams might be composed of players with dissimilar attributes, e.g., as determined by clustering analysis. For example, a team might include a player with a low player level and a player with a high player level, if data in the player profiles indicates that both players would enjoy being on such a team.

Also, in an example embodiment, the players on the same queue might not be otherwise connected by a social graph; that is, to say, they might be not be “friends” or “neighbors” (e.g., as determined by an access control list (ACL)) on a social network maintained by a website hosting a social network or the website hosting the MMO game. However, in an alternative example embodiment, all the players on the same queue might also be “friends” or “neighbors” (e.g., as determined by an access control list (ACL)) on a social network. Or the software at the website hosting the MMO game might apply a filter to the player queue to only select players for a team who are “friends” or “neighbors” on a social network. (Similar filters might be used for other attributes such as recency of gaming activity or to avoid players who have already been removed from the team.) In another example embodiment, the team might be composed of “friends” or “neighbors” on a social network without resort to player queues. For example, software at the website hosting the MMO game might facilitate the creation of a team through GUIs that enable a founder of a team to send invitations (e.g., electronic messages) to his/her “friends” or “neighbors” on a social network, e.g., through an API exposed by website hosting the social network or via a messaging protocol.

In an example embodiment, the software performing the operations shown in FIG. 3 might store the data for the team in a group blob (binary large object) that is separate from other blobs, e.g., the blob that stores the data for players or users. In an example embodiment, the group blob for the team might be identified by a globally unique identifier (GUID) that is a string. It will be appreciated that storing data in blobs facilitates the non-relational (e.g., NoSQL) processing of data using (1) distributed computing software such as Hadoop (which implements Map-Reduce), (2) distributed memory-caching software (such as memcached), and/or (3) distributed key-value database software (such as Membase/Couchbase Server). In an alternative example embodiment, the data for the team or each player might be stored in relational database tables (e.g., SQL tables) that can be distributed across server clusters.

In operation 302, the software assigns an individual game task (e.g., dish) to each player on the team. In an example embodiment, the game mechanics of the MMO game might allow a player to purchase completion of an individual game task can with virtual currency or other virtual game resources. For example, a player might use virtual currency to hire a non-player character (NPC) to help with an individual game task. It will be appreciated that such a game mechanic might be attractive to a player who is a casual gamer who has fallen behind in the performance of his/her individual game task but does not want to prevent his/her team from timely completing their collaborative game task.

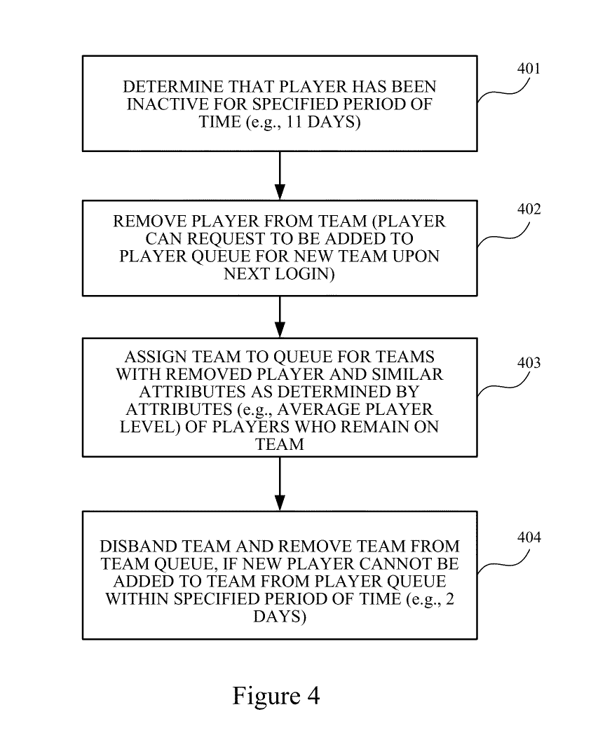

FIG. 4 is a flowchart diagram that illustrates a process for obtaining a new player on a team performing a collaborative game task in an MMO game, in accordance with an example embodiment. In an example embodiment, one or more of the operations in this process might be performed by software (including software 203) running on servers at a website 103, e.g., a website such as Zynga hosting an MMO game. In an alternative example embodiment, one or more of the operations in these processes might be performed by software running on personal computing device 102.

As depicted in FIG. 4, software running on one or more servers at website 103 (e.g., Zynga) determines that a player has been inactive for a specified period of time (e.g., 11 days), in operation 401. In operation 402, the software removes the player from the team. In an example embodiment, the software might allow the removed player to request to be added to a player queue for a new team (e.g., other than the team from which the player has been removed) upon the player's next login. Then, in operation 403, the software assigns the team to a queue for teams (which also might be load-balanced as described elsewhere) with a removed player and similar attributes as determined by the attributes (e.g., average player level) of the players who remain on the team. Here again, the attributes might include age, gender, language, geo-location (e.g., as determined by IP address, device GPS coordinates, etc.), player level, and gaming activity. In operation 404, the software disbands the team and removes the team from the team queue, if a new player cannot be added to the team from a player queue within a specified period of time (e.g., 2 days).

In operation 401, the software determines that a player has been inactive for a specified period of time (e.g., 11 days). It will be appreciated that the specified period of time depends upon numerous factors, including the game mechanics of the MMO game, current game statistics, player profiles, etc. In other example embodiments, the specified time might be less than 11 days or greater than 11 days. Similarly, in operation 404, the software disbands the team and removes the team from the team queue, if a new player cannot be added to the team from a player queue within a specified period of time (e.g., 2 days). Here again, the specified period of time depends upon numerous factors, including the game mechanics of the MMO game, current game statistics, player profiles, etc. In other example embodiments, the specified time might be less than 2 days or greater than 2 days.

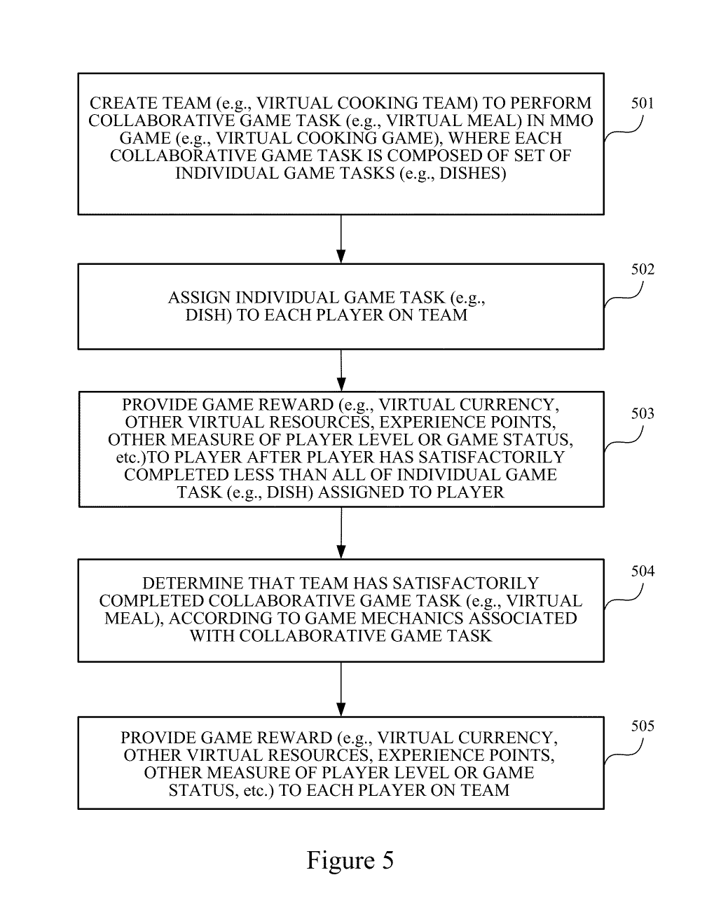

FIG. 5 is a flowchart diagram that illustrates a process for providing game rewards to encourage participation on a team performing a collaborative game task in an MMO game, in accordance with an example embodiment. In an example embodiment, one or more of the operations in this process might be performed by software (including software 203) running on servers at a website 103, e.g., a website such as Zynga hosting an MMO game. In an alternative example embodiment, one or more of the operations in these processes might be performed by software running on personal computing device 102, e.g., instructions in a webpage read by a browser supporting HTML5, CSS3, and JavaScript or instructions in a hybrid app with embedded HTML5 executing on a smartphone.

As depicted in FIG. 5, software running on one or more servers at website 103 (e.g., Zynga) creates a team (e.g., virtual cooking team) to perform a collaborative game task (e.g., virtual meal) in an MMO game (e.g., virtual cooking game), in operation 501. In an example embodiment, the collaborative game task is composed of set of individual game tasks (e.g., dishes). In operation 502, the software assigns an individual game task (e.g., dish) to each player on the team. It will be appreciated that operations 501 and 502 might be performed at the same time, in an example embodiment. In operation 503, the software provides a game reward (e.g., virtual currency, other virtual game resources, experience points, other measure of player level or game status, etc.) to a player after the player has satisfactorily completed less than all of individual game task (e.g., dish) assigned to the player. Then in operation 504, the software determines that the team has satisfactorily completed the collaborative game task (e.g., virtual meal), according to the game mechanics associated with the collaborative game task. And in operation 505, the software provides a game reward (e.g., virtual currency, other virtual game resource, experience points, other measure of player level or game status, etc.) to each player on the team.

In operation 501, the software creates teams. In an example embodiment, teams of a specified size might be created from queues of players (1) who have opted to play the MMO game (e.g., by clicking on a control in a game graphical user interface (GUI)), and (2) who share similar attributes, such as age, gender, language, geo-location (e.g., as determined by IP address, device GPS coordinates, etc.), player level, and gaming activity. In an example embodiment, the queues might be load balanced, e.g., by the addition of a new queue with attributes similar to an existing queue that has grown too long. When assigning players to queues, the software might make a determination as to whether players share similar attributes using clustering analysis, e.g., clustering analysis that depends on a distance between objects (where the objects are players), such as connectivity-based clustering or hierarchy clustering. Some or all of the data as to the player attributes might have been received from a website hosting a social network, e.g., through an application programming interface (API) exposed by that website, in an example embodiment. Or some or all of the data as to player attributes might have come from player profiles maintained by the software at the website hosting the MMO game, including data received from a website hosting a social network. Here again, in an alternative example embodiment, teams might be composed of players with dissimilar attributes, e.g., as determined by clustering analysis. For example, a team might include a player with a low player level and a player with a high player level, if data in the player profiles indicates that both players would enjoy being on such a team.

Also, in an example embodiment, the players on the same queue might not be otherwise connected by a social graph; that is, to say, they might be not be “friends” or “neighbors” (e.g., as determined by an access control list (ACL)) on a social network maintained by a website hosting a social network or the website hosting the MMO game. However, in an alternative example embodiment, all the players on the same queue might also be “friends” or “neighbors” (e.g., as determined by an access control list (ACL)) on a social network. Or the software at the website hosting the MMO game might apply a filter to the player queue to only select players for a team who are “friends” or “neighbors” on a social network. (Similar filters might be used for other attributes such as recency of gaming activity or to avoid players who have already been removed from the team.) In another example embodiment, the team might be composed of “friends” or “neighbors” on a social network without resort to player queues. For example, software at the website hosting the MMO game might facilitate the creation of a team through GUIs that enable a founder of a team to send invitations (e.g., electronic messages) to his/her “friends” or “neighbors” on a social network, e.g., through an API exposed by website hosting the social network or via a messaging protocol.

In an example embodiment, the software performing the operations shown in FIG. 5 might store the data for the team in a group blob (binary large object) that is separate from other blobs, e.g., the blob that stores the data for players or users. In an example embodiment, the group blob for the team might be identified by a globally unique identifier (GUID) that is a string. It will be appreciated that storing data in blobs facilitates the non-relational (e.g., NoSQL) processing of data using (1) distributed computing software such as Hadoop (which implements Map-Reduce), (2) distributed memory-caching software (such as memcached), and/or (3) distributed key-value database software (such as Membase/Couchbase Server). In an alternative example embodiment, the data for the team or each player might be stored in relational database tables (e.g., SQL tables) that can be distributed across server clusters.

In operation 502, the software assigns an individual game task (e.g., dish) to each player on a team. In an example embodiment, the game mechanics of the MMO game might allow a player to purchase completion of an individual game task can with virtual currency or other virtual game resources. For example, a player might use virtual currency to hire a non-player character (NPC) to help with an individual game task. It will be appreciated that such a game mechanic might be attractive to a player who is a casual gamer who has fallen behind in the performance of his/her individual game task but does not want to prevent his/her team from timely completing their collaborative game task.

In operation 504, the software provides a game reward (e.g., virtual currency, other virtual game resources, experience points, other measure of player level or game status, etc.) to a player after the player has satisfactorily completed less than all of an individual game task (e.g., dish) assigned to the player. In an example embodiment, the reward might be provided after the player has completed a specified percentage (e.g., 50%) of his/her individual game task (e.g., dish). In an alternative example embodiment, the reward might be based on a team goal that has been met, e.g., the preparation and/or serving a specified number of virtual dishes (e.g., 300 hamburgers) or the achievement of a specified state (e.g., player level) by each member of the team.

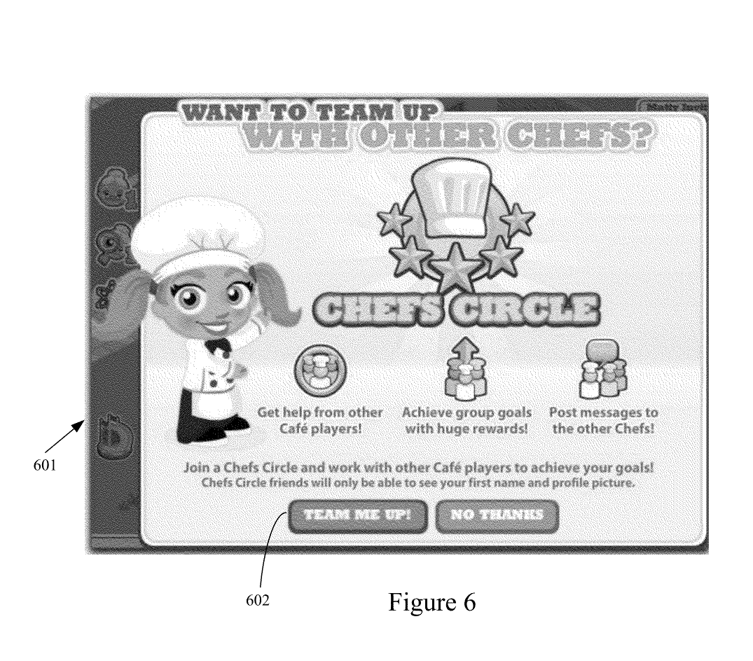

FIG. 6 is a dialog view in a graphical user interface (GUI) that allows a player to join a team performing a collaborative game task in an MMO game, in accordance with an example embodiment. Software running on one or more servers at website 103 (e.g., Zynga) might cause dialog view 601 to be displayed on a personal computing device 102. In an example embodiment, dialog view 601 might be displayed by a browser supporting HTML5, CSS3, and JavaScript or a hybrid app with embedded HTML5 executing on a smartphone. Alternatively, dialog view 601 might be displayed by an Adobe Flash application (e.g., a Small Web Format or SWF file). Dialog view 601 includes a GUI control (or widget) 602, labeled “TEAM ME UP”, which a user can click (e.g., with a mouse) to be placed in a player queue to join a team as described above.

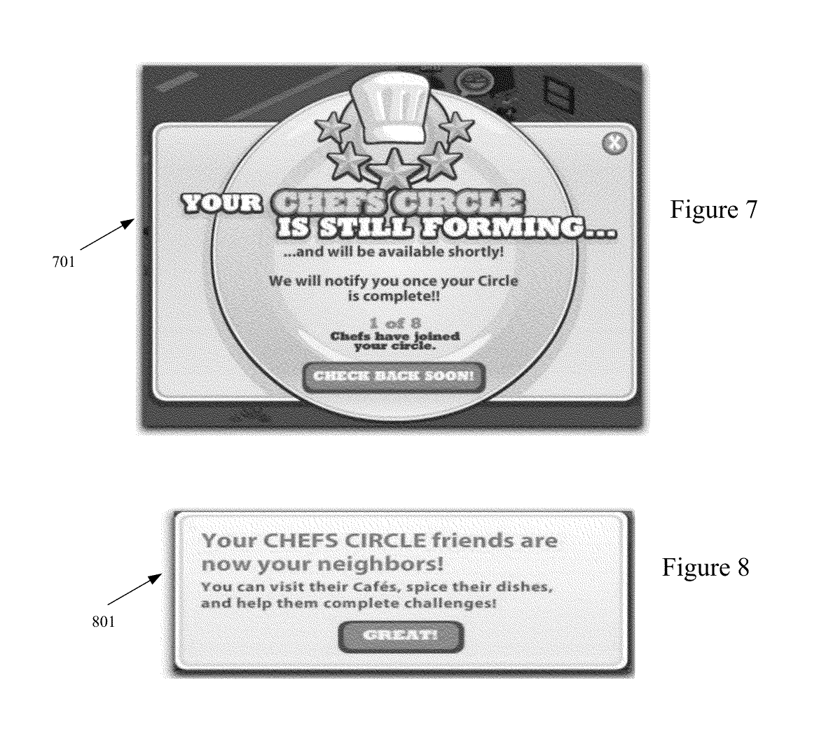

FIGS. 7 and 8 are dialog views in a GUI that notify a player about the status of the formation of the player's team in an MMO game, in accordance with an example embodiment. Software running on one or more servers at website 103 (e.g., Zynga) might cause dialog view 701 in FIG. 7 and dialog view 801 in FIG. 8 to be displayed on a personal computing device 102. In an example embodiment, these dialog views might be displayed by a browser supporting HTML5, CSS3, and JavaScript or a hybrid app with embedded HTML5 executing on a smartphone. Alternatively, these dialog views might be displayed by an Adobe Flash application (e.g., a Small Web Format or SWF file). Dialog view 701 notifies a player waiting for a team that the team has not yet been formed. Dialog view 801 notifies a player that the team has formed and that the members of the team are “neighbors”, e.g., users (or friends) who are associated with each other through access-control lists (ACLs) to form a social network or social graph.

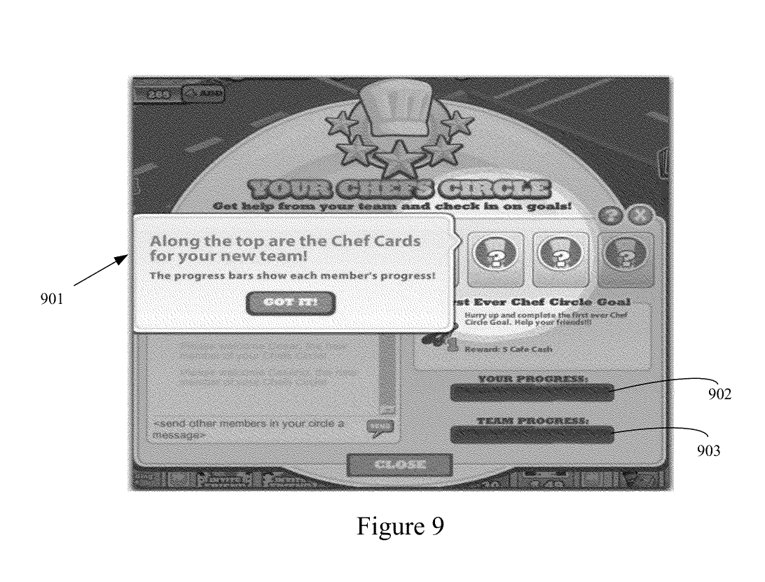

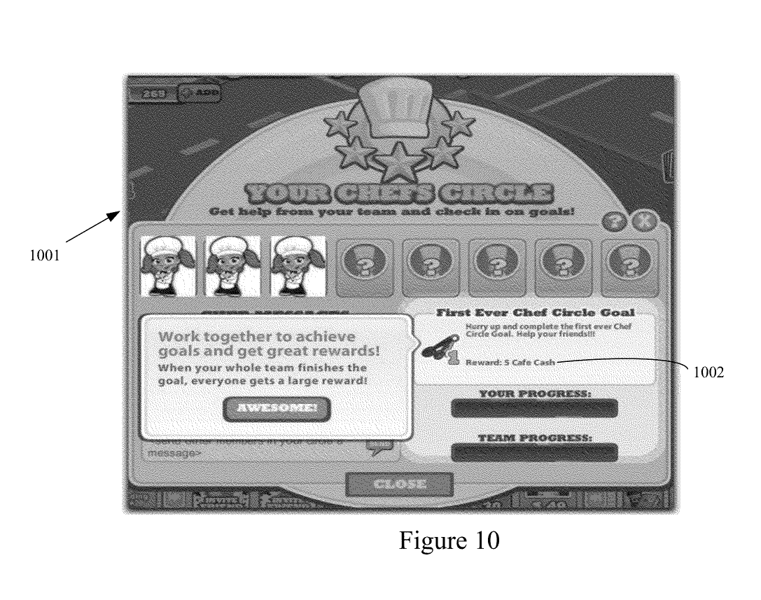

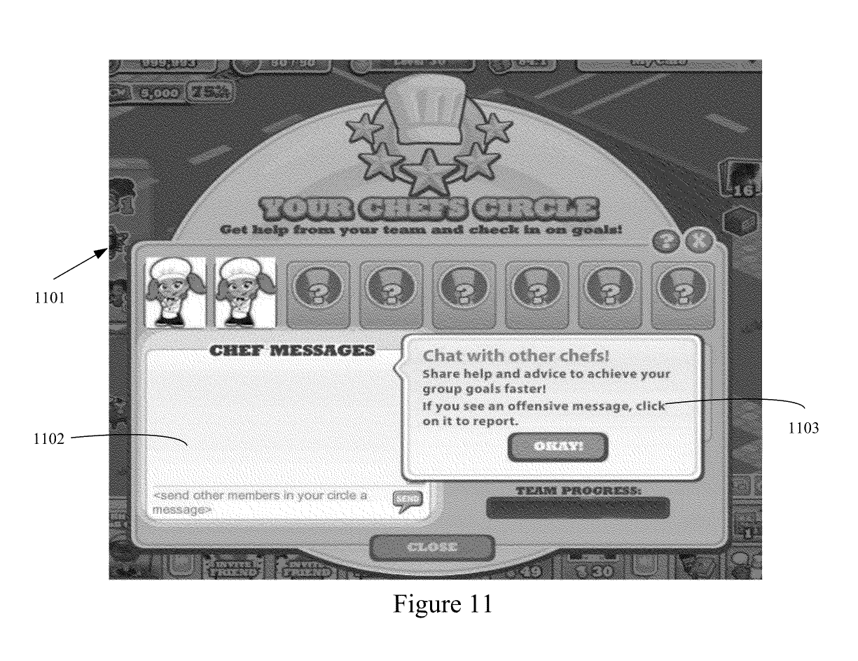

FIGS. 9-11 are dashboard views in a GUI for a team performing a collaborative game task in an MMO game, in accordance with an example embodiment. Software running on one or more servers at website 103 (e.g., Zynga) might cause dashboard view 901 in FIG. 9, dashboard view 1001 in FIG. 10, and dashboard view 1101 in FIG. 11 to be displayed on a personal computing device 102. In an example embodiment, these dashboard views might be displayed by a browser supporting HTML5, CSS3, and JavaScript or a hybrid app with embedded HTML5 executing on a smartphone. Alternatively, these dashboard views might be displayed by an Adobe Flash application (e.g., a Small Web Format or SWF file).

Dashboard view 901 in FIG. 9 includes two progress bars that are GUI controls (or widgets). Progress bar 902 shows the player's progress on an individual game task, e.g., a virtual dish. Progress bar 903 shows the player's team progress on its collaborative game task, e.g., a virtual meal.

Dashboard view 1001 in FIG. 10 shows the reward 1002, which the player's team will receive when it completes the collaborative game task. In this example embodiment, the reward 1002 is virtual currency in the form of “5 Café Cash”.

Dashboard view 1101 in FIG. 11 includes a text entry box 1102 that allows the player to enter messages to the other members of the player's team for distribution by the software running on one or more servers at website 103 (e.g., Zynga), for example, using messaging protocols including instant-messaging protocols. Dashboard view 1101 will also display messages from the other members of the player's team, though such messages are not shown in FIG. 11. As indicated by dialog box 1103, the software running on one or more servers at website 103 (e.g., Zynga) might also include functionality to remove an offensive message that is reported by a player. In an example embodiment, a player who has sent an offensive message more than a specified number of times (e.g., 2 or 3 times after being warned about such messages) might be removed from the team. And if such a player has been removed from other teams for such behavior a specified number of times (e.g., 2 or 3 times after being warned about such messages), the player might not be eligible to join another team (e.g., be banned from further participation in the MMO game).

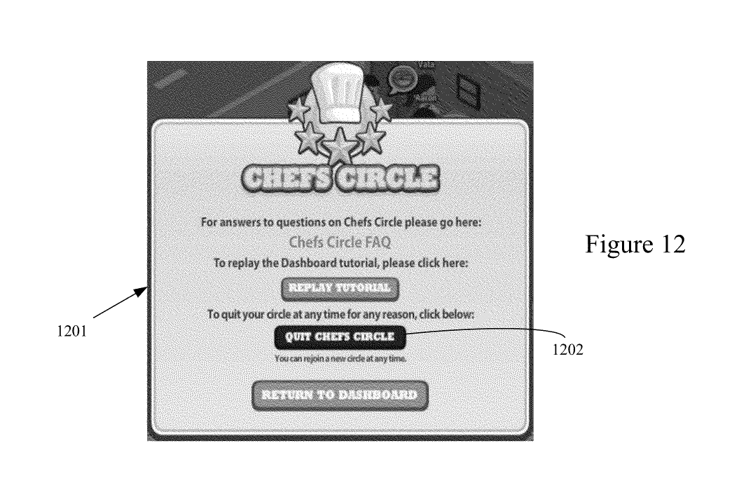

FIG. 12 is a dialog view in a GUI that allows a player to quit a team performing a collaborative game task in an MMO game, in accordance with an example embodiment. Software running on one or more servers at website 103 (e.g., Zynga) might cause dashboard view 1201 in FIG. 12 to be displayed on a personal computing device 102. In an example embodiment, dialog view 1201 might be displayed by a browser supporting HTML5, CSS3, and JavaScript or a hybrid app with embedded HTML5 executing on a smartphone. Alternatively, this dialog view might be displayed by an Adobe Flash application (e.g., a Small Web Format or SWF file). Dialog view 1201 includes a GUI control (or widget) 1202, labeled “QUIT CHEF′S CIRCLE”, which a user can click (e.g., with a mouse) to explicitly quit the collaborative game task. It will be appreciated that a player can also implicitly quit a collaborative game task, e.g., by not participating in the player's individual game task. In an example embodiment, a player who quits a team might be treated as a player who is removed from a team for not participating as described above, e.g., the player might be eligible to join another team with attributes similar to the player's attributes.

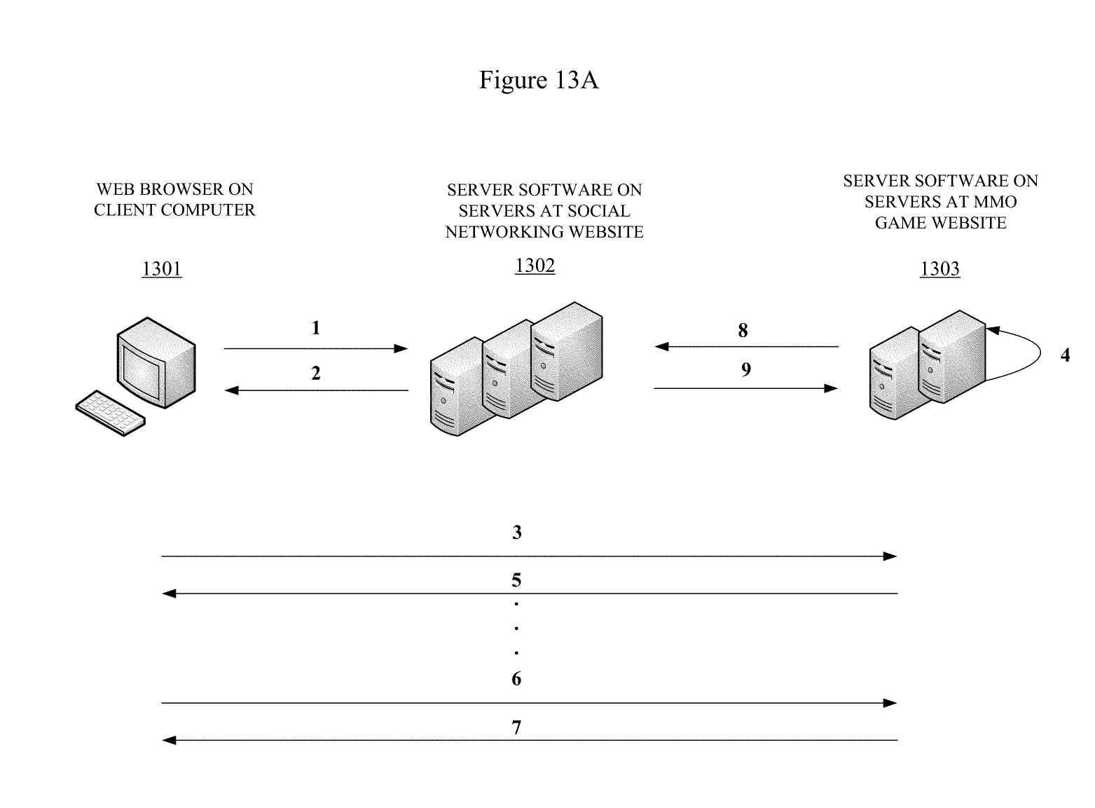

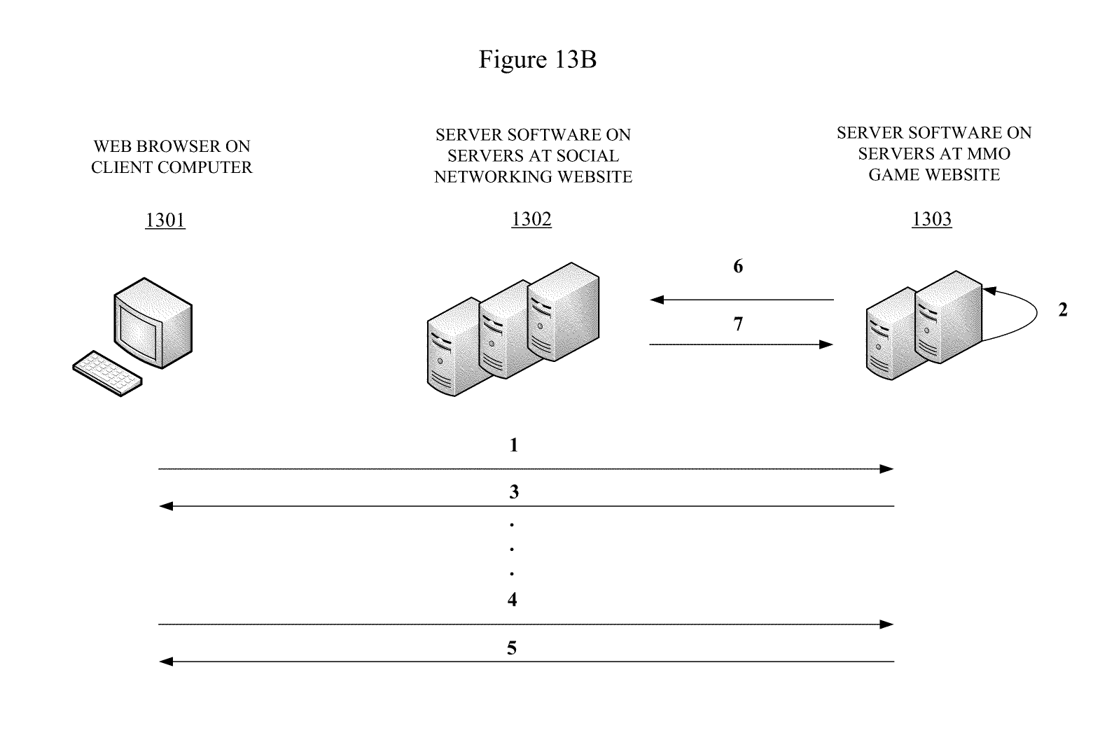

FIG. 13A is a simplified diagram that illustrates a sequence of transmissions associated with an individual game task (e.g., preparing a virtual dish in a virtual meal) in an MMO game accessed from a social networking website, in accordance with an example embodiment. As depicted in this diagram, a player has used a browser 1301 on a personal computing device to log onto a social networking website, e.g., server software 1302 (e.g., Facebook). However, many of the transmissions described in this figure and FIG. 13B might also occur if a player using a smartphone were to run a hybrid app written in Objective C or Java that includes embedded HTML5.

In operation 1, the player clicks on a graphic for a social MMO game, causing browser 1301 to transmit an HTTP request to server software 1302 (e.g., Facebook) for the game's initial web page. In operation 2, server software 1302 (e.g., Facebook) returns an HTML5 and JavaScript (JS) web page consisting of an iFrame (e.g., Facebook “chrome”) and an iFrame HTML tag for the game's initial web page. In operation 3, the browser uses the HTML tag to transmit a request to server software 1303 (e.g., Zynga) for the game's initial web page to display inside the iFrame. The game's initial web page might be an application server page (e.g., PHP 5) or an HTML5 page. In operation 4, the application server page executes on server software 1303 (e.g., Zynga), resulting in requests to databases and other servers as needed to complete generation of the web page, including possibly an HTTP request (not shown) transmitted to an API exposed by server software 1302 (e.g., Facebook). In operation 5, the server software 1303 (e.g. Zynga) returns the game's initial web page (e.g., HTML5 and JS) for the browser to display in the iFrame.

At some point thereafter, in operation 6, the player clicks on a graphic (e.g., representing a graphical user interface or GUI widget) on a game web page (e.g., HTML5 and JS), causing browser 1301 to transmit an HTTP request to server software 1303 (e.g., Zynga), requesting assistance with an individual game task (e.g., requesting a virtual ingredient from the player's friends on a social network, possibly including friends who are not members of the player's team or even presently players of the MMO game). In operation 7, the server software 1303 (e.g. Zynga) returns a web page (e.g., HTML5 and JS) to the browser indicating that the request was received. In operation 8, the server software 1303 (e.g., Zynga) transmits an HTTP request to an API exposed by server software 1302 (e.g., Facebook), posting the request for assistance with an individual game task to the profiles (e.g., through a Facebook notification) and/or streams of the requesting player's friends on the social network managed by server software 1302 (e.g., Facebook). It will be appreciated that in order to access the friends' profiles and/or streams (e.g., using an access token), the server software 1303 (e.g., Zynga) might have earlier obtained permission from the friends, e.g., when they joined the game or other Zynga games. Then in operation 9, server software 1302 (e.g., Facebook) sends a response, e.g., in Java Script Object Notation (JSON), to server software 1303 (e.g., Zynga) describing the success or failure of the posting to each profile and/or stream.

In an alternative example embodiment, the game's initial web page (or some subsequent web page served up by the game) might have an Adobe Flash application (e.g., a Small Web Format or SWF file) embedded in it. In this alternative example embodiment, the user of browser 1301 might thereafter interact with the Adobe Flash application (e.g., its GUI), causing it to interact with the server software 1302 (e.g., Facebook) and the server software 1303 (e.g., Zynga).

FIG. 13B is a simplified diagram that illustrates a sequence of transmissions associated with an individual game task (e.g., preparing a virtual dish in a virtual meal) in an MMO game accessed from an MMO game website, in accordance with an example embodiment. In operation 1, the player clicks on a graphic for a social MMO game, causing browser 1301 to transmit an HTTP request to server software 1303 (e.g., Zynga) for the game's initial web page. The game's initial web page might be an application server page (e.g., PHP 5) or an HTML5 page. In operation 2, the application server page executes on server software 1303 (e.g., Zynga), resulting in requests to databases and other servers as needed to complete generation of the web page, including possibly an HTTP request (not shown) transmitted to an API exposed by server software 1302 (e.g., Facebook). In operation 3, the server software 1303 (e.g. Zynga) returns the game's initial web page (e.g., HTML5 and JS) for the browser to display.

At some point thereafter, in operation 4, the player clicks on a graphic (e.g., representing a GUI widget) on a game web page (e.g., HTML5 and JS), causing browser 1301 to transmit an HTTP request to server software 1303 (e.g., Zynga), requesting assistance with an individual game task (e.g., requesting a virtual ingredient from the player's friends on a social network, possibly including friends who are not members of the player's team or even presently players of the MMO game). In operation 5, the server software 1303 (e.g. Zynga) returns a web page (e.g., HTML5 and JS) to the browser indicating that the request was received. In operation 6, the server software 1303 (e.g., Zynga) transmits an HTTP request to an API exposed by server software 1302 (e.g., Facebook), posting the request for assistance with an individual game task to the profiles (e.g., through a Facebook notification) and/or streams of the requesting player's friends on the social network managed by server software 1302 (e.g., Facebook). Here again, it will be appreciated that in order to access the friends' profiles and/or streams (e.g., using an access token), the server software 1303 (e.g., Zynga) might have earlier obtained permission from the friends, e.g., when they joined the game. Then in operation 7, server software 1302 (e.g., Facebook) sends a response, e.g., in JSON, to server software 1303 (e.g., Zynga) describing the success or failure of the posting to each profile and/or stream.

In an alternative example embodiment, the game's initial web page (or some subsequent web page served by the game) might have an Adobe Flash application (e.g., a Small Web Format or SWF file) embedded in it. In this alternative example embodiment, the user of browser 1301 might thereafter interact with the Adobe Flash application (e.g., its GUI), which, in turn, might interact with the server software 1302 (e.g., Facebook) and the server software 1303 (e.g., Zynga).

In an example embodiment, a collaborative game task might be a virtual meal (e.g., at a virtual catering event). Software at a website hosting an MMO game might facilitate the definition of the virtual meal by a player, e.g., by allowing the player to select a virtual meal from a list of virtual meals (e.g., Italian, French, Mexican, etc.), using a graphical user interface (GUI). The software might also allow the player to solicit help completing the virtual dishes in the virtual meal from the player's “friends” or “neighbors” (e.g., as determined by an access control list (ACL)) on a social network maintained by a website hosting a social network or the website hosting the MMO game. For example, the software might allow the player to send a communication (e.g., electronic messages) to a “friend” or “neighbor” on a social network, e.g., through an API exposed by website hosting the social network or via a messaging protocol, asking the “friend” or “neighbor” to complete a virtual dish in the virtual meal, as part of a team in a competition against another team composed of “friends” or “neighbors” on a social network. During the competition, the software might facilitate the replacement of a team member who is not participating, as described above. In an example embodiment, team members might be permitted to switch teams, e.g., in order to enhance competition. In an example embodiment, the competition between the teams might end when one team has satisfactorily completed the team's virtual meal, according to the game mechanics associated with the collaborative game task.

Though the disclosure above has focused on MMO games, some or all of the operations described above might be used in a gamification application rather than in an MMO game. It will be appreciated that gamification involves the use of game design techniques, game thinking, and game mechanics to enhance tasks performed in non-game contexts. So for example, some or all of the operations described above might be used in an employee training program involving a collaborative task.

With the above embodiments in mind, it should be understood that the inventions might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the inventions are useful machine operations. The inventions also relate to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The inventions can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

Although example embodiments of the inventions have been described in some detail for purposes of clarity of understanding, it will be apparent that certain changes and modifications can be practiced within the scope of the following claims. The operations described above can be ordered, modularized, and/or distributed in any suitable way. Accordingly, the present embodiments are to be considered as illustrative and not restrictive, and the inventions are not to be limited to the details given herein, but may be modified within the scope and equivalents of the following claims. In the following claims, elements and/or steps do not imply any particular order of operation, unless explicitly stated in the claims or implicitly required by the disclosure.

What is claimed is:

1. A method for engaging players in a massively multiplayer online (MMO) game, comprising the operations of:
creating a team to perform a collaborative game task in the MMO game, wherein the collaborative game task is composed of a plurality of individual game tasks and wherein each player on the team is assigned an individual game task;
removing an existing player from the team, if the existing player is not participating;
assigning a new player to the team;
determining that the team has satisfactorily completed the collaborative game task, according to game mechanics associated with the collaborative game task; and
providing a game reward to each player on the team, wherein each operation of the method is executed by one or more processors.

2. The method of claim 1, wherein each player on the team is assigned from a queue of players who share one or more attributes.

3. The method of claim 2, wherein the attributes include age, gender, language, geo-location, player level, and gaming activity.

4. The method of claim 2, wherein data as to the one or more attributes is received from a social networking website through an application programming interface (API) exposed by the social networking website.

5. The method of claim 2, wherein the new player is assigned from a queue determined by the attributes of the players who remain on the team.

6. The method of claim 2, wherein a determination as to whether players share similar attributes depends at least in part on clustering analysis.

7. The method of claim 1, wherein data for the team is stored in a group blob rather than a blob for players.

8. The method of claim 1, wherein completion of an individual game task can be purchased with virtual currency.

9. A computer-readable storage medium persistently storing a program, wherein the program, when executed, instructs one or more processors to perform the following operations:
create a team to perform a collaborative game task in the MMO game, wherein the collaborative game task is composed of a plurality of individual game tasks and wherein each player on the team is assigned an individual game task;
remove an existing player from the team if the existing player is not participating;
assign a new player to the team;
determine that the team has satisfactorily completed the collaborative game task, according to game mechanics associated with the collaborative game task; and
provide a game reward to each player on the team.

10. The computer-readable storage medium of claim 9, wherein each player on the team is assigned from a queue of players who share one or more attributes.

11. The computer-readable storage medium of claim 10, wherein the attributes include age, gender, language, geo-location, player level, and gaming activity.

12. The computer-readable storage medium of claim 10, wherein data as to the one or more attributes is received from a social networking website through an application programming interface (API) exposed by the social networking website.

13. The computer-readable storage medium of claim 10, wherein the new player is assigned from a queue determined by the attributes of the players who remain on the team.

14. The computer-readable storage medium of claim 10, wherein a determination as to whether players share similar attributes depends at least in part on clustering analysis.

15. The computer-readable storage medium of claim 9, wherein data for the team is stored in a group blob rather than a blob for players.

16. The computer-readable storage medium of claim 9, wherein completion of an individual game task can be purchased with virtual currency.

17. An apparatus for engaging players in a massively multiplayer online (MMO) game, comprising:
one or more processors; and
memory in communication with the one or more processors and storing processor-executable instructions comprising instructions to:
create a team to perform a collaborative game task in the MMO game, wherein the collaborative game task is composed of a plurality of individual game tasks and wherein each player on the team is assigned an individual game task;
remove an existing player from the team, if the existing player is not participating;
assign a new player to the team;
determine that the team has satisfactorily completed the collaborative game task, according to game mechanics associated with the collaborative game task; and
provide a game reward to each player on the team.

18. The apparatus of claim 17, wherein each player on the team is assigned from a queue of players who share one or more attributes.

19. The apparatus of claim 18, wherein the attributes include age, gender, language, geo-location, player level, and gaming activity.

20. The apparatus of claim 18, wherein data as to the one or more attributes is received from a social networking website through an application programming interface (API) exposed by the social networking website.
